(19) United States
(12) Patent Application Publication
(10) Pub. No.: US 2025/0205727 A1
(43) Pub. Date: Jun. 26, 2025

(54) FOUNTAIN DEVICE

(71) Applicant: Baozhang LIAO, Fujian (CN)

(72) Inventor: Baozhang LIAO, Fujian (CN)

(21) Appl. No.: 18/604,523

(22) Filed: Mar. 14, 2024

(30) Foreign Application Priority Data
Dec. 22, 2023 (CN) 2023235288860

(51) Int. Cl. B05B 17/08

(52) U.S. Cl. CPC B05B 17/08

(57) ABSTRACT

A fountain device includes a base, water storage basin mounted on the base, a mounting base and a water pump that are mounted in the water storage basin, a spray head mounted on the mounting base, and a power supply module mounted outside the water storage basin; a water outlet end of the water pump is in communication with a water inlet end of the spray head; a drive end of the water pump is electrically connected with a power output end of the power supply module. The fountain device may be mounted at any position simply and conveniently. As the spray head uses water in the water storage basin and achieves fountain effect through the water pump, the construction of the fountain device is simple, and water sprayed by the spray head flows back into the water storage basin to achieve recycling.

### BACKGROUND OF THE INVENTION

The present invention relates to the technical field of fountains, and in particular to a fountain device.

A fountain is a device that sprays water under certain pressure through a spray head to form a landscape. With the development of cities and the improvement of people's living standards, people pursue diversity of modern life, and fountain devices continue to appear and are widely used in squares, communities, playgrounds or scenic spots of the cities. However, most of the existing fountain devices are large, making them cumbersome to build and mount, and the existing fountain devices have relatively simple shape designs which limit their aesthetic appeal, and are not convenient to improve ornamental performance of the fountain.

In view of this, the present application is directed to further research on the basis of the above, and thus the present solution is devised.

### BRIEF SUMMARY OF THE INVENTION

The object of the present invention is to provide a fountain device that is beautiful in shape and convenient to build and mount.

To attain this, the present invention provides the following solution:

A fountain device comprising a water storage basin, a mounting base and a water pump mounted in the water storage basin, a spray head mounted on the mounting base, and a power supply module mounted outside the water storage basin; a spray hole is provided on an upper end of the spray head; a water outlet end of the water pump is in communication with a water inlet end of the spray head; a drive end of the water pump is electrically connected with a power output end of the power supply module to enable power supply from the power supply module to the water pump.

The power supply module comprises a battery and a control circuit; the battery is in form of a storage battery; a first power input end of the control circuit is electrically connected to a power output end of the battery; a first power output end of the control circuit constitutes the power output end of the power supply module.

The battery is in form of a charging and discharging battery; the control circuit is in form of a charging and discharging control circuit; a solar panel is laid on an upper side surface of the water storage basin, and an output end of the solar panel is electrically connected to a second power input end of the control circuit; a second power output end of the control circuit is electrically connected to a power input end of the battery.

A mounting box is detachably provided outside the water storage basin; the power supply module is located in the mounting box.

The fountain device further comprises a base; the water storage basin is mounted on the base; the base is of a basin-shaped structure or a cylindrical structure.

A light-emitting lamp is disposed on a bottom part of the water storage basin and/or a lower side of an upper edge of the water storage basin and/or an upper side of the mounting base; a power supply end of the light-emitting lamp is electrically connected to a third power output end of the control circuit.

A switch button is mounted on an outer side or the upper side surface of the water storage basin; the switch button is electrically connected to a first signal input end of the control circuit.

A sensing probe is disposed on the water storage basin at a position close to the switch button; the sensing probe has a collecting end which is electrically connected to a second signal input end of the control circuit.

The fountain device further comprises a remote switch electrically connected to a third signal input end of the control circuit.

The spray head having a hollow interior is rotatably mounted on the mounting base; a spiral member for driving rotation of the spray head is disposed in the interior of the spray head; the spray hole is more than one in number; the more than one spray holes are circumferentially arranged at intervals on the spray head.

The spiral member comprises a connecting rod and a spiral structure disposed on the connecting rod; the spiral structure comprises a spiral blade which spirals from bottom to top of the connecting rod; a first end of the connecting rod is mounted at a top part of the spray head, and a second end of the connecting rod is adjacent to an upper end surface of the mounting base.

The spiral member is located on an upper side inside the spray head; the spiral member comprises a connecting rod and a spiral structure disposed on the connecting rod; the spiral structure comprises a plurality of spiral blades which are arranged around the connecting rod; each of the spiral blades is slanted clockwise or counterclockwise from top to bottom.

An ornamental member is disposed outside the top part of the spray head.

The ornamental member is connected to the spray head through a hard elastic member; the ornamental member is made of a light-transmitting material, and/or the hard elastic member is in form of a rope made of a light-transmitting material.

A decorative cover is disposed on the water storage basin; the decorative cover is provided with a plurality of water inlet gaps, and each of the water inlet gaps communicates with an interior of the water storage basin.

The decorative cover is mounted on the water storage basin in a manner such that the decorative cover is capable of automatic rotation under impact of water flow; the decorative cover comprises an annular ring and a plurality of rotating blades which are arranged around the annular ring; each of the rotating blades has a blade surface which is arranged to incline downwards in a clockwise or counterclockwise direction, and the water inlet gap is formed between every two adjacent rotating blades.

The decorative cover is made of a light-transmitting material.

A hand grip is provided at an outer side wall of the mounting base or an inner side wall of the water storage basin.

After adopting the structure, the present invention has the following beneficial effects:
1. The water storage basin of the present invention may be mounted at any position simply and conveniently; as the spray head uses water in the water storage basin and achieves fountain effect through the water pump, the construction of the present invention is simple, and water sprayed by the spray head flows back into the water storage basin to achieve recycling; in addition, the water storage basin is mounted on the base, and the spray head is disposed on the mounting base on the water storage basin, so that the present invention is simple and beautiful in shape, and has better ornamental performance when the spray head sprays water.
2. The present invention adopts a rotatable spray head and a spiral member; when water flow enters the spray head, the water flow impacts the spiral member, so that the spiral member rotates to drive the spray head to rotate synchronously, and water flow is sprayed out from the spray holes to achieve automatic rotation of the spray head, thereby resulting in better ornamental performance.
3. In the present invention, an ornamental member is connected to the spiral member, and the ornamental member may be in different shapes according to actual situations; in this way, when the spiral member automatically rotates under the impact of the water flow, the spiral member also drives the ornamental member to rotate, thereby further improving aesthetic appeal and ornamental performance; in addition, the ornamental member may be a transparent one, so that the present invention is more beautiful, and has better ornamental performance.
4. According to the present invention, the decorative cover is disposed on the water storage basin to further improve the aesthetic appeal of the present invention, and each rotating blade rotates under the impact of water flow separately sprayed out from each spray hole, so that the aesthetic appeal, the ornamental performance, and entertainment value of the present invention are further improved; in addition, the decorative cover may be a transparent cover, so that the present invention is more beautiful, and has better ornamental performance.
5. The present invention may have various charging modes, such as solar charging or direct current power supply charging, thereby achieving functional diversification, and a user may select the charging mode according to his needs, which is more suitable for the needs of the user.
6. A light-emitting lamp is disposed in the present invention, so that the aesthetic appeal of the present invention is further improved, and the present invention has better ornamental performance.

### BRIEF DESCRIPTION OF THE DRAWINGS

FIG. 1 is a schematic diagram of a structure of Embodiment 1.

FIG. 2 is a schematic diagram of a preferred structure of Embodiment 1.

FIG. 3 is a schematic diagram of another preferred structure of Embodiment 1.

FIG. 4 is a cross-sectional view of Embodiment 2 with the water pump omitted.

FIG. 5 is a schematic diagram of a structure of the spiral member in FIG. 4.

FIG. 6 is a cross-sectional view of another structure of Embodiment 2.

FIG. 7 is a schematic diagram of a structure of the spiral member in FIG. 6.

FIG. 8 is a cross-sectional view of Embodiment 3 with the water pump omitted.

FIG. 9 is a schematic diagram of a structure of the decorative cover according to Embodiment 3.

FIG. 10 is a schematic diagram of a structure of Embodiment 4.

FIG. 11 is a cross-sectional view of the fountain body according to Embodiment 4 with the water pump omitted.

FIG. 12 is a schematic diagram of a structure of the fountain body according to Embodiment 5.

FIG. 13 is a schematic diagram of a structure of the light-emitting lamp according to Embodiment 7.

FIG. 14 is a schematic diagram of a circuit of the power supply module according to Embodiment 1.

FIG. 15 is a schematic diagram of another circuit of the power supply module according to Embodiment 1.

FIG. 16 is a schematic diagram of the power supply module according to Embodiment 1, in which the remote switch is added.

FIG. 17 is a schematic diagram of a structure of Embodiment 1, in which hand grips are added.

FIG. 18 is a schematic diagram of another structure of the hand grips as shown in FIG. 17.

FIG. 19 is a schematic diagram of another structure as shown in FIG. 1.

FIG. 20 is a schematic diagram of the power supply module of Embodiment 1 with a sensing probe added.

In the Figures:
10: fountain body; 101: light-emitting lamp; 20: base; 30: ornamental member; 301: hard elastic member; 60: power supply module; 61: control circuit; 6011: first power input end of the control circuit; 6012: second power input end of the control circuit; 6021: first power output end of the control circuit; 6022: second power output end of the control circuit; 6023: third power output end of the control circuit; 62: battery; 603: power output end of the battery; 604: power input end of the battery; 605: drive end of the water pump; 606: output end of the solar panel; 607: first signal input end of the control circuit; 608: power supply end of the light-emitting lamp; 609: second signal input end of the control circuit;
1: water storage basin; 11: annular groove; 12: clamping slot; 13: annular extension disc; 14: accommodating base; 15: sensing probe; 2: mounting base; 21: clamping block; 22: inlet and outlet part; 23: mounting protrusion; 24: bearing; 25: bearing; 26: middle column; 27: hand grip; 3: water pump; 4: spray head; 401: spray head body; 402: top cover; 41: spray hole; 42: spiral member; 422: connecting rod; 423: spiral structure; 5: water-conveying channel; 6: mounting box; 7: solar panel; 71: switch button; 72: remote switch; 8: mounting assembly; 81: insertion part; 82: extension part; 9: decorative cover; 91: annular ring; 92: rotating blade; 921: water inlet gap.

### DETAILED DESCRIPTION OF THE INVENTION

In order to further explain the technical solutions of the present invention, a detailed description of the present invention is provided below through specific embodiments.

### Embodiment 1

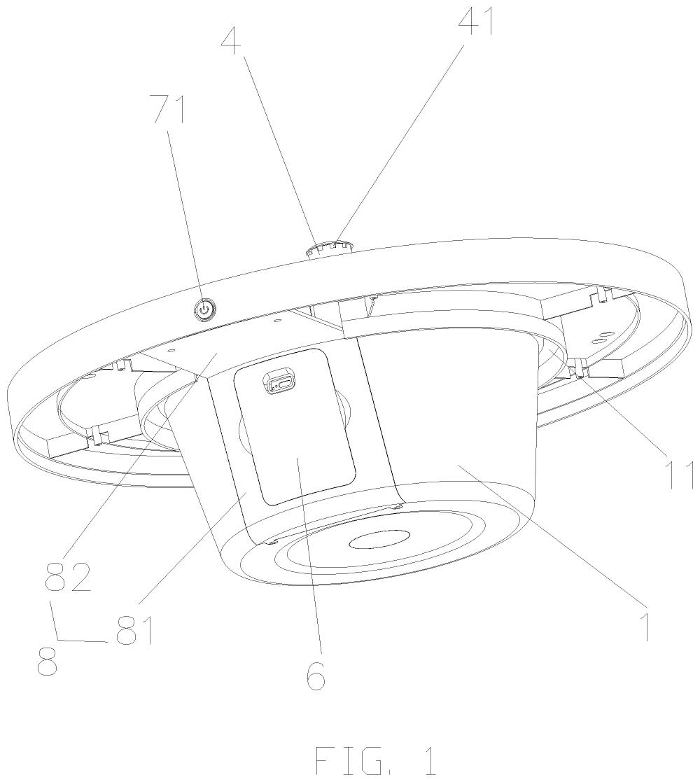

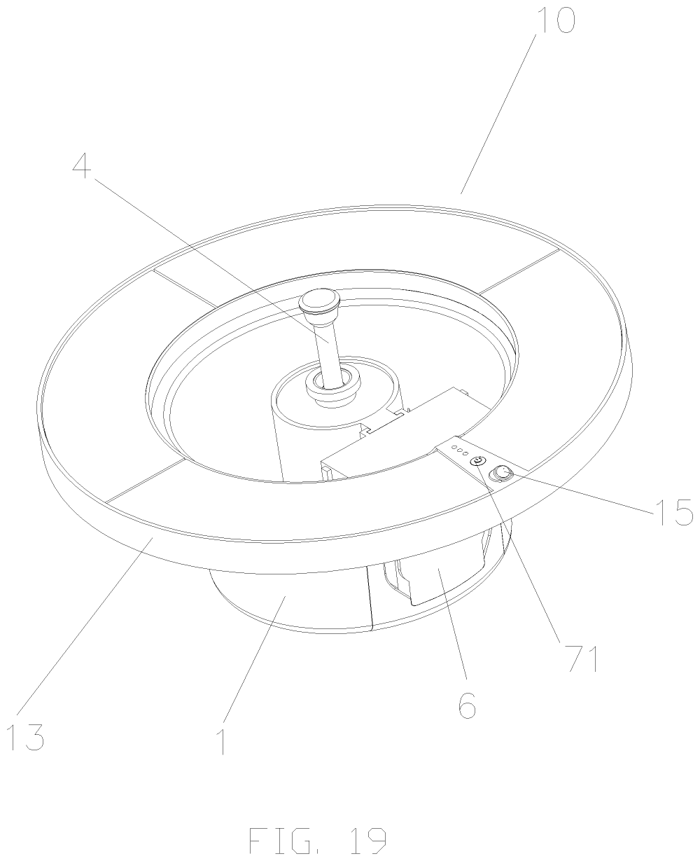

A fountain device, as shown in FIG. 1 to FIG. 3 and FIG. 14 to FIG. 19, comprises a fountain body 10. For convenience of description, the orientation of the present invention in use is used as a reference orientation of the present invention. The fountain body 10 comprises a water storage basin 1 for storing water, a mounting base 2 and a water pump 3 that are mounted in the water storage basin 1, a spray head 4 mounted on the mounting base 2, and a power supply module mounted outside the water storage basin 1. The power supply module provides working power for the water pump 3. The spray head 4 is of a hollow structure, preferably a hollow cylindrical structure. An upper end of the spray head 4 is circumferentially provided with a plurality of spray holes 41. The spray holes 41 are arranged around the axis of the spray head 4 as the center, so as to spray water out from the water storage basin 1 to form a fountain landscape. In addition, the interior of the spray head 4 communicates with a water outlet end of the water pump 3, so that the water pump 3 can pump water in the water storage basin 1 and convey the water to the spray head 4 for spraying, thereby forming the fountain landscape.

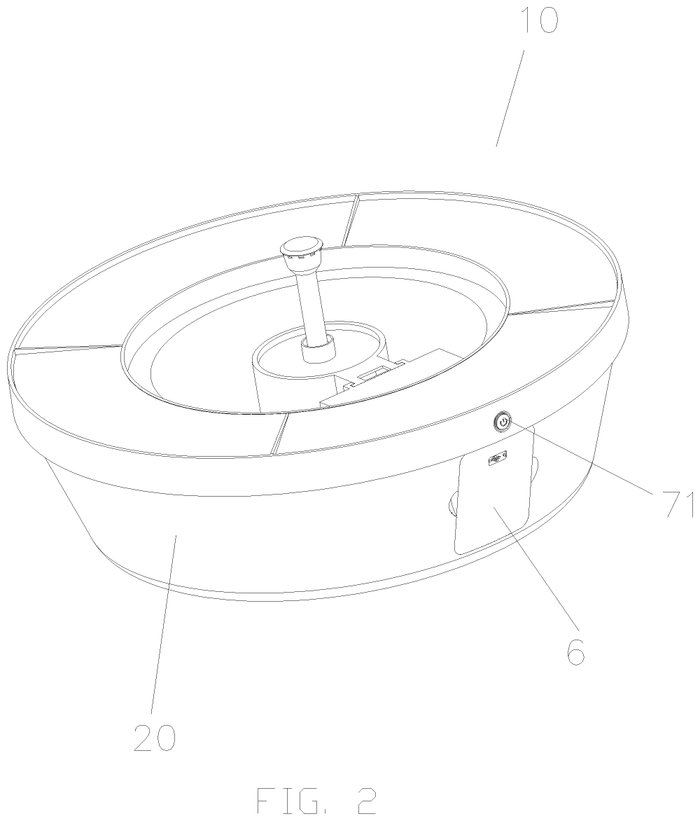

Preferably, as shown in FIG. 2, a base 20 is mounted on the outside of the water storage basin 1. The base 20 is of a basin-shaped structure, so that the water storage basin 1 can be conveniently disposed in the base, and the present invention can be directly placed at a desired position.

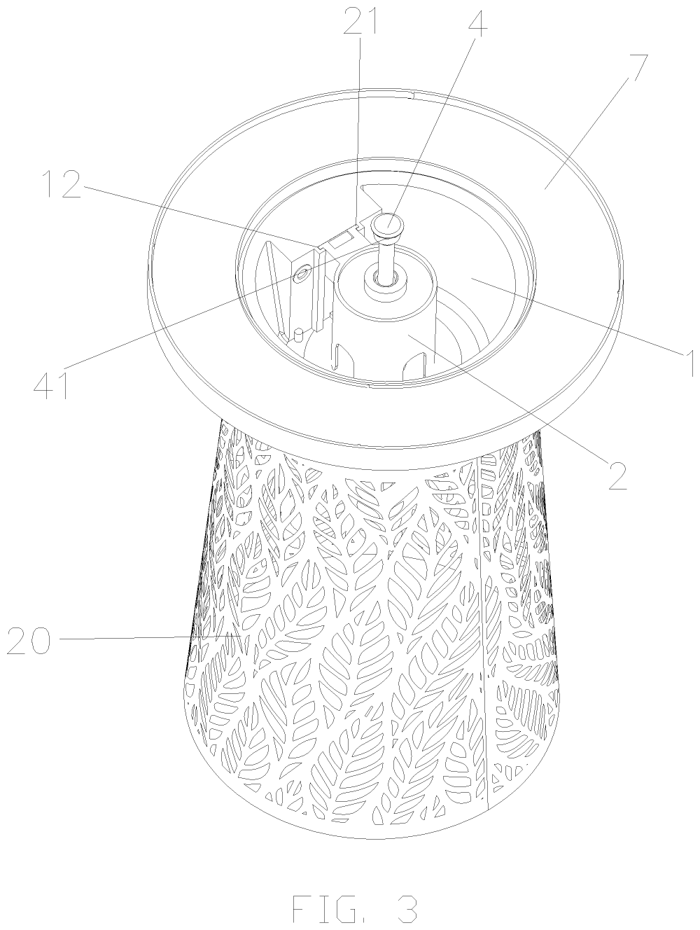

Preferably, as shown in FIG. 3, in order to improve aesthetic appeal, the fountain device further comprises a base 20. The water storage basin 1 is detachably mounted on the base 20. The base 20 is used for being placed on conventional sites such as the ground or a flat ground. The base 20 is of a cylindrical structure, and the base 20 has a diameter gradually decreasing from bottom to top. In addition, the base 20 may be of a hollow cylindrical structure whose transverse cross section is of a conventional geometric structure like a triangle, a rhombus, a square or a star shape. It should be noted that the structure of the base 20 is set according to actual situations, and is not limited to the foregoing structures. Preferably, the base 20 may further be provided with a pattern. The pattern may comprise a plurality of leaf-shaped hollow parts, butterfly-shaped hollow parts, or flower-shaped hollow parts. The specific pattern is adjusted according to actual market demands.

Further, the base 20 is mounted at the bottom of the water storage basin 1 in the following manner: an annular groove 11 is disposed at a periphery of a lower side of an upper edge of the water storage basin 1, and an upper side edge of the base 20 and the annular groove 11 are in insertion fit. In this embodiment, the mounting structure of the base 20 and the water storage basin 1 may alternatively be other conventional mounting structures. For example, the base 20 may be mounted to the water storage basin 1 by snap fit or bolt mounting.

It should be noted that the base 20 may be added according to actual situations. If the base 20 is not needed, the base may be omitted. If needed, then the base 20 may be mounted on the water storage basin 1.

Further, as shown in FIG. 3, the mounting base 2 is of a cylindrical structure, and the mounting base 2 is provided with an upper end surface. A water-conveying channel 5 is disposed at a middle position of the upper end surface of the mounting base 2. A first end of the spray head 4 extends out of the water storage basin 1, and a second end of the spray head 4 is mounted at the mounting base 2 at a position that corresponds to a water outlet end of the water-conveying channel 5, so that the second end of the spray head 4 communicates with the water-conveying channel 5.

The water pump 3 is mounted in the basin of the water storage basin 1, and is located within a surrounding range of the mounting base 2, so that the water pump 3 is hidden to improve overall aesthetic appeal. In addition, the water outlet end of the water pump 3 communicates with a water inlet end of the water-conveying channel 5, so that the water pump 3 can pump the water in the water storage basin 1, and the water enters the spray head 4 through the water-conveying channel 5 for spraying. It should be noted that a plurality of inlet and outlet parts 23 for water to enter or exit are circumferentially disposed on the bottom of the mounting base 2, so that water can freely enter or exit from the mounting base 2. In addition, the mounting base 2 may also be disposed in a suspending manner, so that a spacing is formed between the bottom of the mounting base 2 and the inner bottom of the water storage basin 1 to avoid interruption of water flow.

Preferably, in order to improve the overall aesthetic appeal of the present invention, the upper end surface of the mounting base 2 is located inside the water storage basin 1 and does not protrude out of an upper side surface of the water storage basin, and the first end of the spray head 4 extends out of the water storage basin 1.

Further, the mounting base 2 is detachably mounted at a middle position inside the water storage basin 1 in the following manner: an inner side wall of the water storage basin 1 is provided with two clamping slots 12 that are arranged opposite to each other and extend from top to bottom; an outer side wall of the mounting base 2 is convexly provided with a T-shaped clamping block 21, with two sides of the clamping block 21 respectively in one-to-one clamping fit with the two clamping slots 12. In addition, the mounting base 2 may alternatively be mounted in the water storage basin 1 by using other conventional structures. For example, the mounting base 2 may be mounted in the water storage basin 1 by insertion fit or bolt mounting.

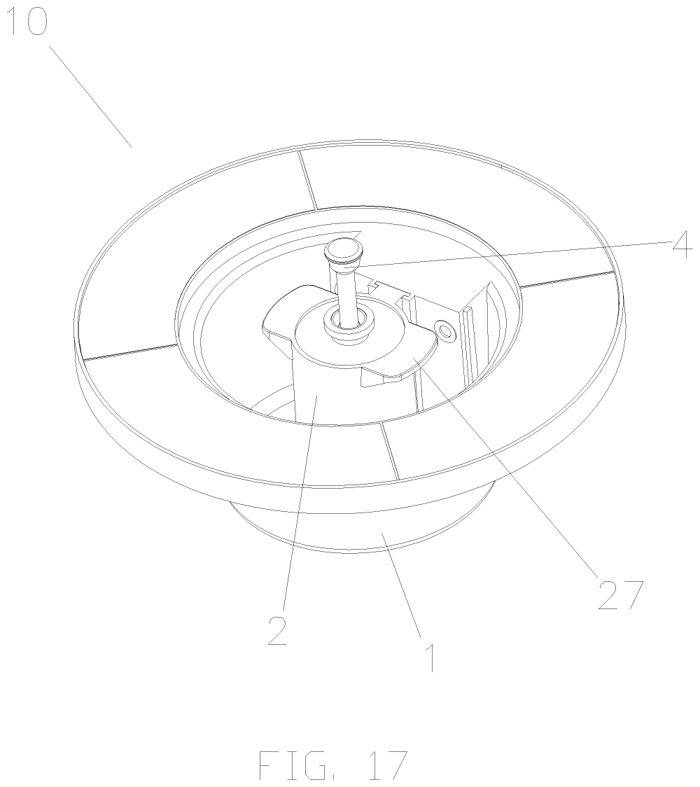

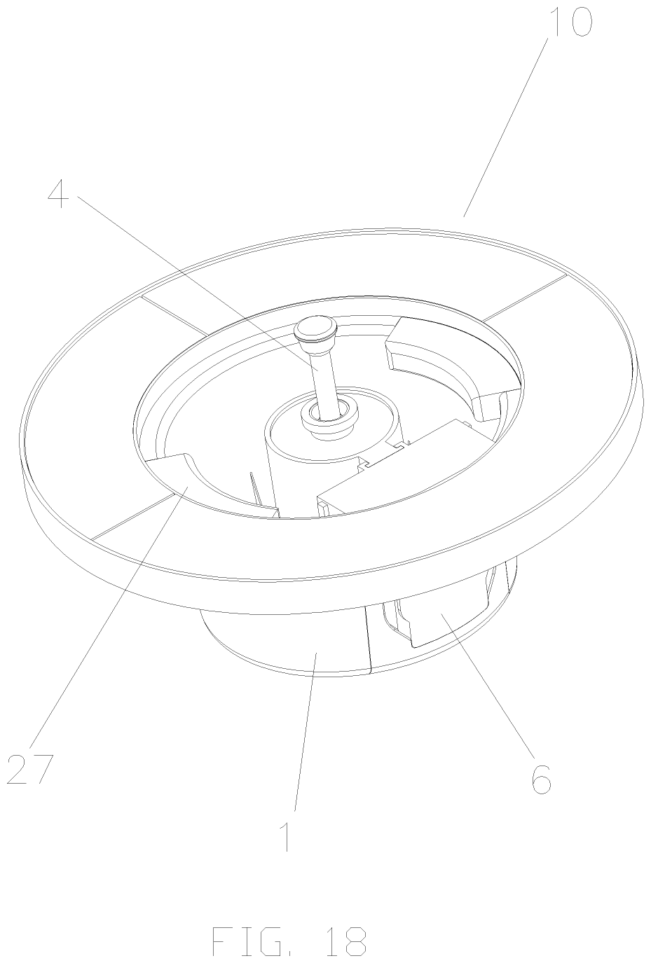

Preferably, as shown in FIG. 17, a hand grip 27 is integrally formed at an upper side of the outer side wall of the mounting base 2. The hand grip 27 is extended outwards to facilitate mounting of the fountain body 10 at the base or other mounting positions or detachment of the fountain body from the base or other mounting positions. Preferably, to facilitate usage, two hand grips 27 are provided and the two hand grips 27 are arranged opposite to each other. Furthermore, as shown in FIG. 18, the hand grip 27 may also be provided at an upper edge of the inner side wall of the water storage basin 1.

Further, the spray head 4 comprises a spray head body 401 of a cylindrical structure and a top cover 402 covering the spray head body. The top cover 402 is detachably mounted on an upper end of the spray head body 401. The top cover 402 and the spray head body 401 are coaxially arranged, and the top cover 402 and the spray head body 401 may be mounted together by using a conventional mounting structure; for example, the top cover 402 and the spray head body 401 are in bonding fit; and for another example, the top cover 402 and the spray head body 401 are in clamping fit, that is, a lower side surface of the top cover 402 is provided with an annular groove, and an upper end edge of the spray head body 401 is clamped into the annular groove, wherein the upper end edge of the spray head body 401 is circumferentially provided with a plurality of openings, and after the spray head body 401 and the top cover 402 are mounted to each other, the spray holes 41 are formed between the openings and a lower end surface of the top cover 402.

Further, the outer side surface of the water storage basin 1 is detachably provided with a mounting box 6. In this embodiment, the outer side surface of the water storage basin 1 is inwardly provided with a concave cavity where the mounting box 6 is tightly inserted, and an outer side surface of the mounting box 6 is connected to the outer side surface of the water storage basin 1 to improve aesthetic appeal and ornamental performance of the overall appearance. Preferably, the two clamping slots 12 are disposed at the inner side wall of the water storage basin 1 at a position which corresponds to the concave cavity. Preferably, the mounting box 6 is located on an inner side of the base 20, that is, the base 20 can hide the mounting box 6, so that the overall appearance is simple and elegant.

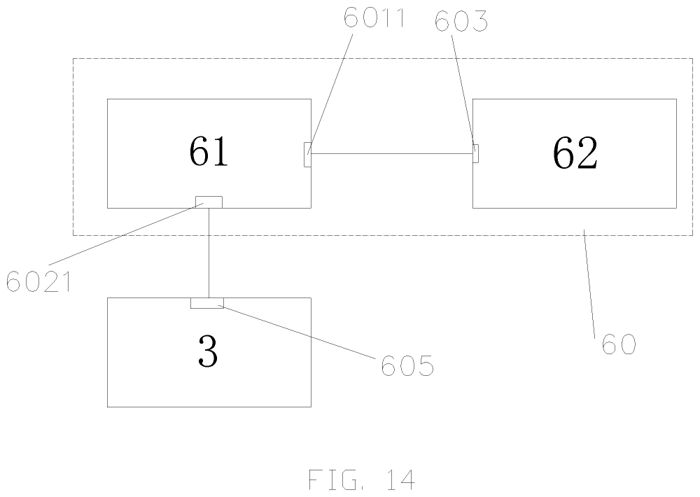

The power supply module is mounted in the mounting box 6 for water proofing purposes. As shown in FIG. 14, the power supply module comprises a battery 62 and a control circuit 61. A power output end 603 of the battery 62 is connected to a first power input end 6011 of the control circuit 61 through a wire, a first power output end 6021 of the control circuit 61 is electrically connected to a drive end 605 of the water pump 3 so as to supply power to the water pump 3 from the battery 62, and the first power output end 6021 of the control circuit 61 constitutes a first power output end of the power supply module. In this embodiment, the battery 62 is a conventional storage battery charged by using a conventional interface like a USB interface or a Type-C interface, and the control circuit 61 is an existing conventional control circuit for controlling a corresponding electrical device to be on or off.

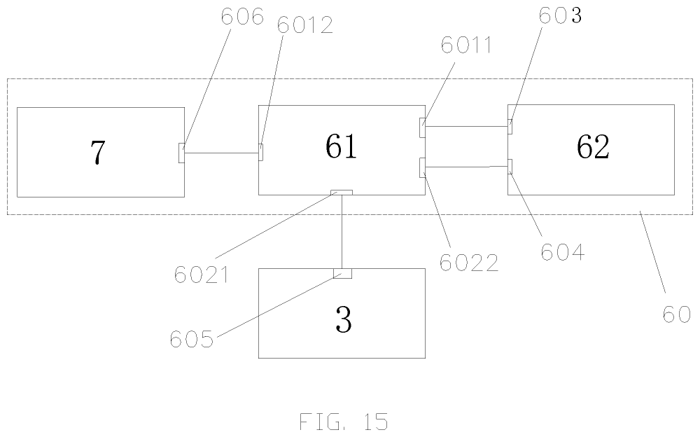

Preferably, as shown in FIG. 15, this embodiment may furthermore adopt solar power supply, that is, the power supply module 60 further comprises a solar panel 7. The solar panel 7 is laid on the upper side surface of the water storage basin 1 and surrounds a basin opening of the water storage basin 1. The control circuit 61 is a charging and discharging control circuit, and the battery 62 is a charging and discharging battery. A specific circuit connection structure is that the control circuit 61 and the charging and discharging battery 62 are in a bidirectional electric connection, that is, a second power output end 6022 of the control circuit 61 is connected to a power input end 604 of the battery 62 through a wire, so that electric energy stored in the solar panel 7 can be used for charging the battery 62 through the control circuit, and the first power input end 6011 of the control circuit 61 is connected to the power output end 603 of the battery 62 through a wire, so that the battery 62 can supply power to the water pump 3 through the control circuit 61.

Further, an upper edge of the water storage basin 1 extends outward to form an annular extension disc 13, that is, the water storage basin 1 and the annular extension disc 13 are of an integral connection structure. The annular extension disc 13 is located in a range that accommodates the water sprayed by the spray head 4, so as to prevent the water from falling out of the device. Preferably, in order to facilitate the flow of water back into the water storage basin 1, an upper side surface of the annular extension disc 13 is arranged to incline downwards towards a middle position of the water storage basin 1.

It should be noted that if the device adopts solar energy as a power supply source, the solar panel 7 fits the annular extension disc 13, and the solar panel 7 is laid on the annular extension disc 13. The solar panel 7 may be one or more in number, which are specifically set according to actual situations and are not limited herein. In this way, the solar panel 7 can be used as a part of the whole embodiment, and the fountain body 10 can be powered by itself, thereby ensuring the overall aesthetic appeal and fully utilizing resources.

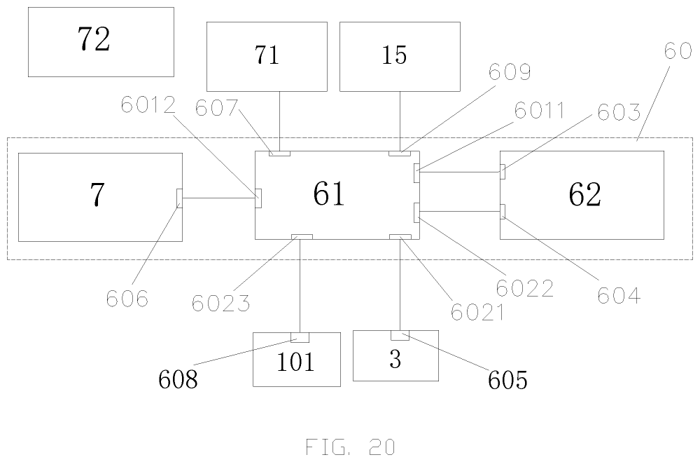

Further, as shown in FIG. 1 and FIG. 19 to FIG. 20, a switch button 71 is mounted on an outer side of the water storage basin, and the switch button 71 is connected to a first signal input end 607 of the control circuit 61 through a wire, so that the device could be switched on or off through the switch button 71. In this embodiment, the switch button 71 may also be disposed on the upper side surface of the water storage basin 1, that is, the switch button 71 may be disposed on the upper side surface of the annular extension disc 13. Preferably, the switch button 71 may be a touch button; the switch button may also be other conventional button such as conventional mechanical button or the like, which is specifically set according to actual situations and are not limited herein.

As a preferred embodiment, a sensing probe 15 is disposed on the the water basin 1 at a position close to the switch button 71. The sensing probe 15 has a collecting end which is electrically connected to a second signal input end 609 of the control circuit 61, so that the device could be switched on or off upon sensing the presence of human in the vicinity. The sensing probe 15 may be conventional human sensing components such as conventional infrared sensor.

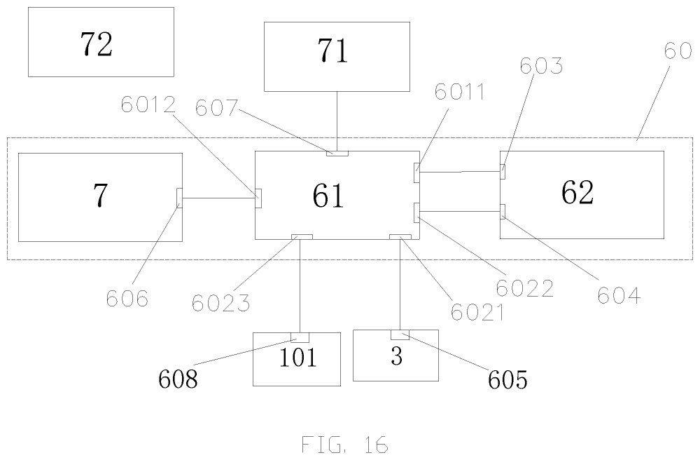

Preferably, as shown in FIG. 16, the device further comprises a remote switch 72, so that the device is remotely controlled by the remote switch 72 to be on or off. The remote switch 72 and the control circuit 61 are in a conventional remote connection, that is, the remote switch 72 is connected to a third signal input end of the control circuit 61. It should be noted that the device may select one or more of the foregoing modes for turning on or off, and the device may alternatively be turned on or off by adopting other conventional switch mode.

Preferably, a mounting assembly 8 is mounted in the concave cavity. The mounting assembly 8 comprises an insertion part 81 for inserting the mounting box 6 and an extension part 82 extending to a lower side surface of the annular extension disc 13. A hollow interlayer is formed between the extension part 82 and the lower side of the upper edge of the water storage basin 1, so that the wires are hidden in the hollow interlayer to ensure the overall aesthetic appeal of the present invention.

### Embodiment 2

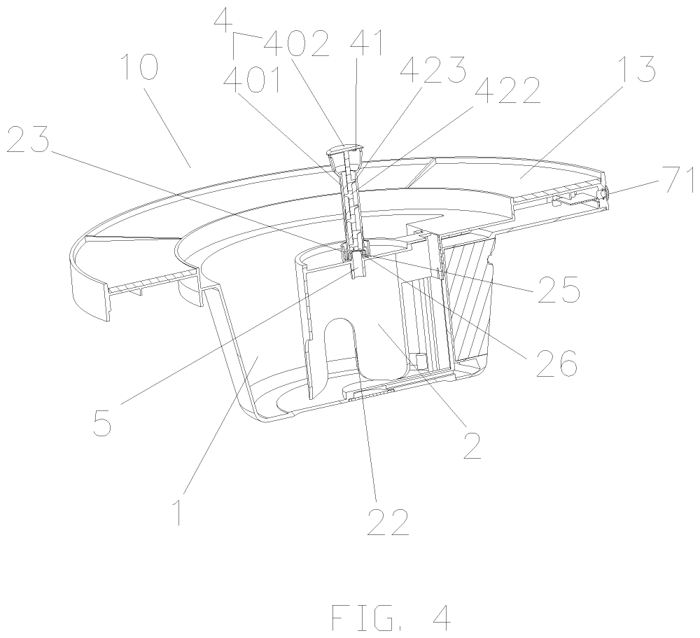

As shown in FIG. 4 to FIG. 7, this embodiment differs from Embodiment 1 in that the spray head 4 is mounted on the upper end surface of the mounting base 2 in a manner such that the spray head 4 is capable of automatic rotation under impact of water flow.

Specifically, the spray head 4 is rotatably mounted on the mounting base 2, and a spiral member 42 is disposed in the spray head 4. The spiral member 42 comprises a connecting rod 422 and a spiral structure disposed on the connecting rod 422. The connecting rod 422 extends from top to bottom, and a first end (namely, an upper end) of the connecting rod 422 is connected to a middle position of the lower end surface of the top cover 402. The connecting rod 422 and the top cover 402 may adopt a conventional connecting structure like integral connection, insertion fit, or snap fit. A second end (namely, a lower end) of the connecting rod 422 directly faces the water inlet end of the water-conveying channel 5. The spiral structure is driven by water flow to rotate, so as to drive the connecting rod 422 to rotate, thereby driving the spray head 4 to rotate.

There are two type of spiral structure. The two types of structure are described in detail below.

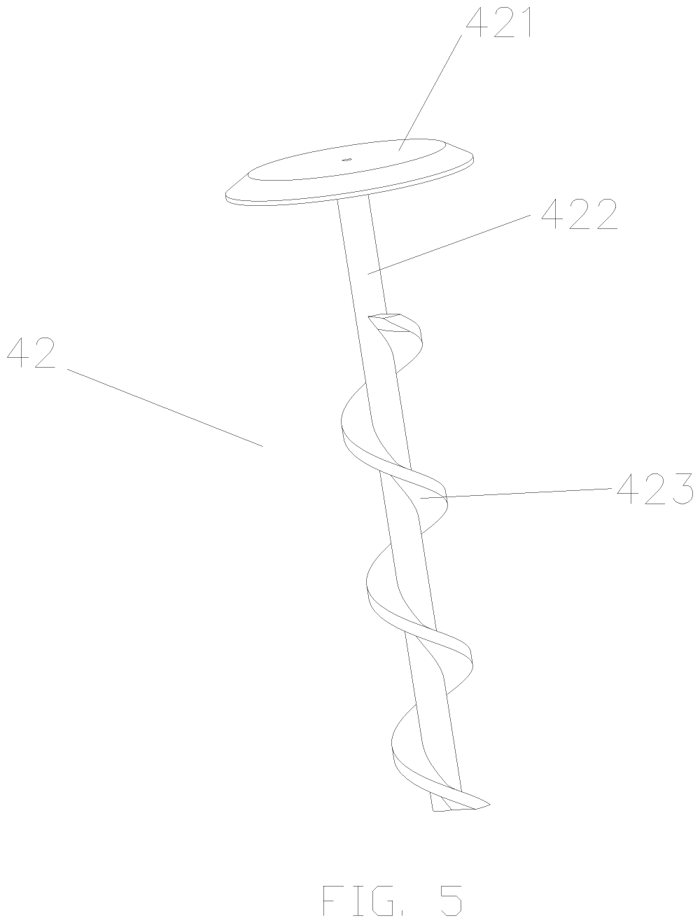

According to the first type of structure, as shown in FIG. 4 and FIG. 5, the spiral structure comprises a spiral blade 423 which spirals from bottom to top of the connecting rod 422. Preferably, the connecting rod 422 and the spiral blade 423 are of an integral connection structure, and the lower end of the connecting rod 422 is adjacent to the upper end surface of the mounting base 2.

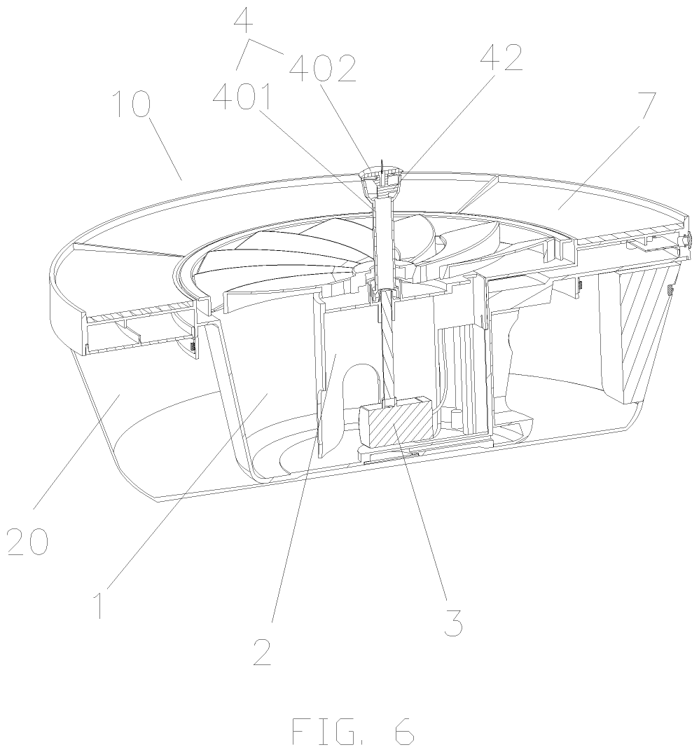

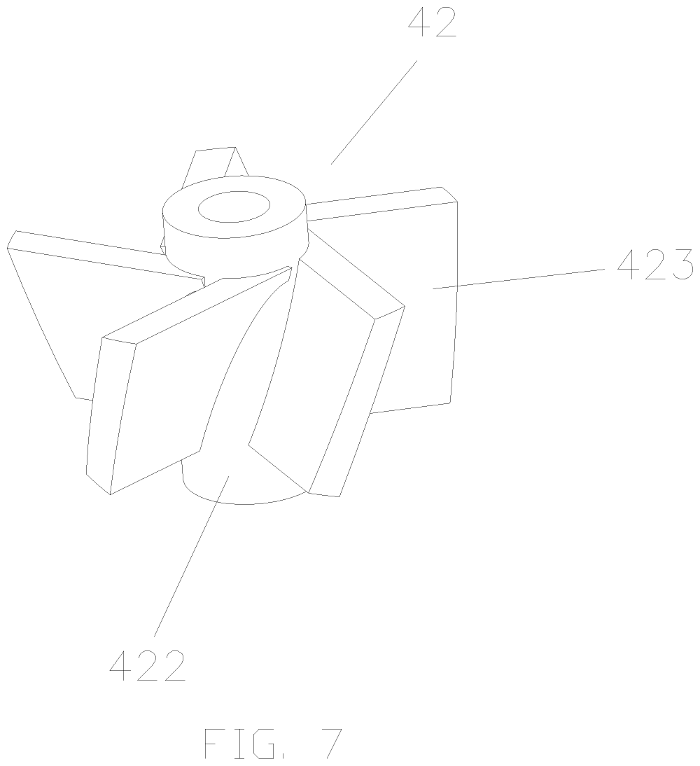

According to the second type of structure, as shown in FIG. 6 and FIG. 7, the connecting rod 422 is located on an upper side inside the spray head 4, and the spiral structure comprises a plurality of spiral blades 423. The spiral blades 423 are arranged around the connecting rod 422, centering on the axis of the connecting rod 422, and the connecting rod 422 and the spiral blades 423 are of an integral connection structure. The spiral blades 423 are slanted in the same direction from bottom to top. In this embodiment, the spiral blades 423 are slanted counterclockwise from bottom to top so as to push the spiral member to rotate.

Further, a hollow middle column 26 extends upwards and downwards at a middle position of the mounting base 2. The inside of the middle column 26 forms the water-conveying channel 5. A lower end of the spray head 4 is rotatably mounted on an outer side of the middle column 26. A rotating structure of the spray head 4 is as follows: the outer side of the middle column is sleeved with a bearing 25, and the lower end of the spray head 4 is mounted on the bearing 25, so that the spray head 4 rotates relative to the middle column 26. In addition, the rotating structure of the spray head 4 may alternatively adopt other conventional structure. For example, a key connection is implemented between the lower end of the spray head 4 and the middle column.

According to a fountain device in this embodiment, during operation, the water pump pumps the water in the water storage basin 1 into the spray head 4 through the water-conveying channel 5. The water flow starts to rotate through the spiral structure and drives the whole spiral member 42 to rotate. Because the upper ends of the connecting rod 422 and the spray head 4 are connected to each other, the spray head 4 starts to rotate, centering on the axis of the middle column, and water flow is sprayed out from the spray holes 41 to form a rotating flow structure. In this way, the spray head 4 automatically rotates under impact of the water flow in this embodiment, and the structure is simple and has ornamental performance.

### Embodiment 3

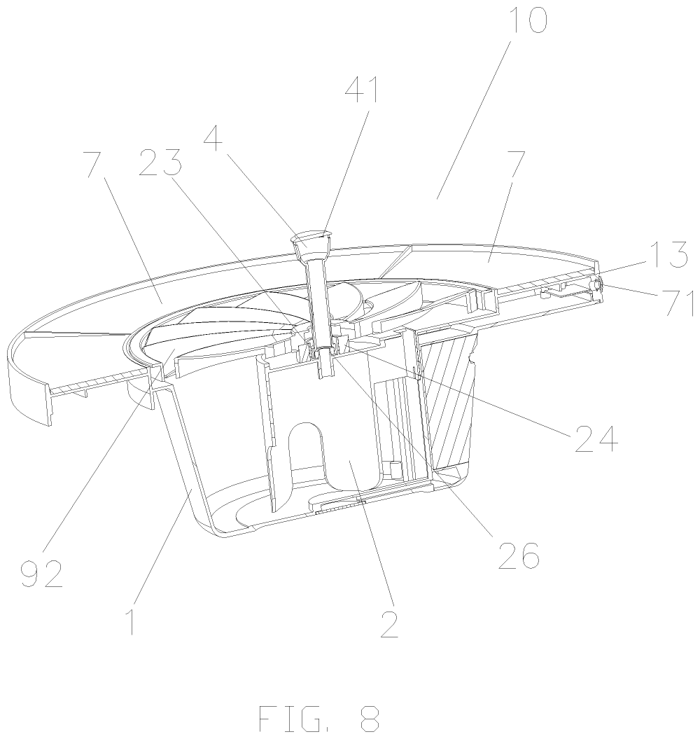

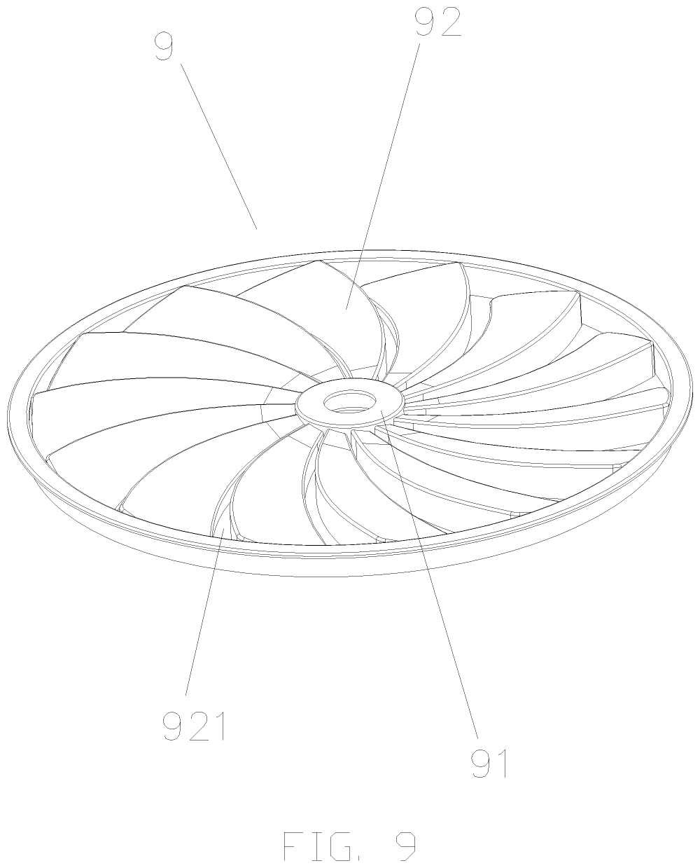

As shown in FIG. 8 and FIG. 9, this embodiment differs from Embodiment 1 in that a decorative cover 9 is disposed on the water storage basin 1, so that the inside of the water storage basin 1 is hidden to further improve the overall aesthetic appeal; in addition, the decorative cover is provided with a plurality of water inlet gaps, and each of the water inlet gaps communicates with the water storage basin 1.

Further, the decorative cover 9 is mounted on the water storage basin 1 in a manner such that the decorative cover is capable of automatic rotation under impact of water flow. Specifically, the decorative cover 9 is rotatably mounted on the mounting base 2, and the decorative cover 9 fits the opening of the water storage basin 1. The decorative cover 9 comprises an annular ring 91 and a plurality of rotating blades 92. The annular ring 91 and the water-conveying channel 5 are coaxially arranged. The rotating blades 92 are sequentially arranged around the axis of the annular ring 91 as the center, and a first end of each rotating blade 92 is integrally connected to an outer side wall of the annular ring 91. A blade surface of each rotating blade is arranged to incline downwards in the clockwise or counterclockwise direction. In this embodiment, the blade surface of each rotating blade is arranged to incline downwards in the counterclockwise direction. The blade surface of each rotating blade corresponds to an adjacent side surface of an adjacent rotating blade in the counterclockwise direction, and the water inlet gap 921 is formed between every two adjacent rotating blades 92, so that the water from the spray head 4 returns to the water storage basin 1 through the water inlet gaps 921.

It should be noted that a gap exists between a second end of each rotating blade 92 and the inner side wall of the water storage basin 1 to facilitate rotation of the rotating blades 92.

Further, the decorative cover 9 is rotatably mounted on the mounting base 2 in a conventional manner. Specifically, the upper end surface of the mounting base 2 is provided with a mounting protrusion 23 around the middle column 26 as the center, the mounting protrusion 23 is tightly sleeved with a bearing 24, and the annular ring 91 is sleeved outside the bearing 24.

According to a fountain device in this embodiment, during operation, the water pump pumps the water in the water storage basin 1 into the spray head 4 through the water-conveying channel 5, and the water flows out through the spray holes 41 and falls onto the rotating blades 92 to push side surfaces of the rotating blades to rotate and further push the rotating blades 92 to rotate, thereby improving the ornamental performance of the device.

### Embodiment 4

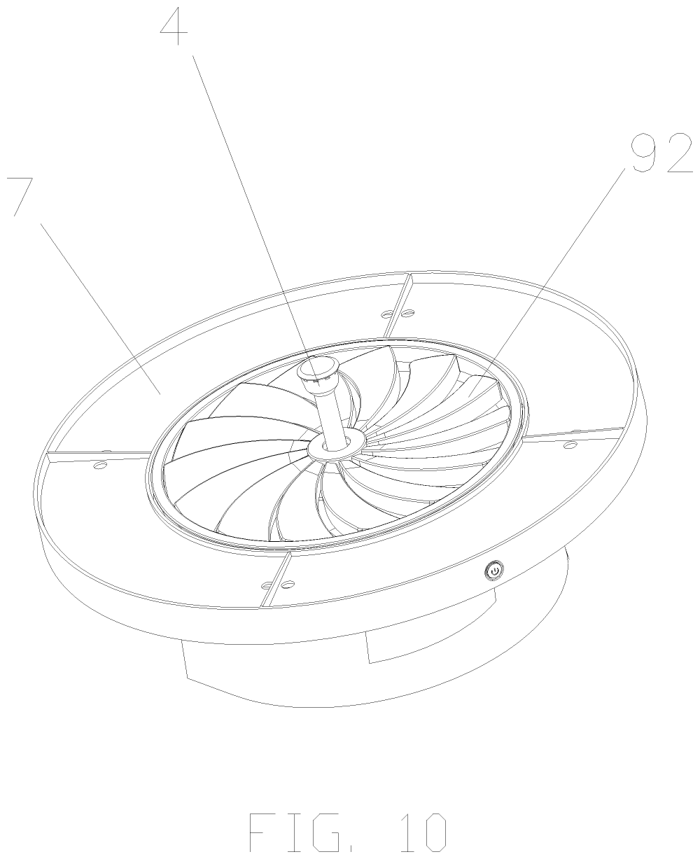

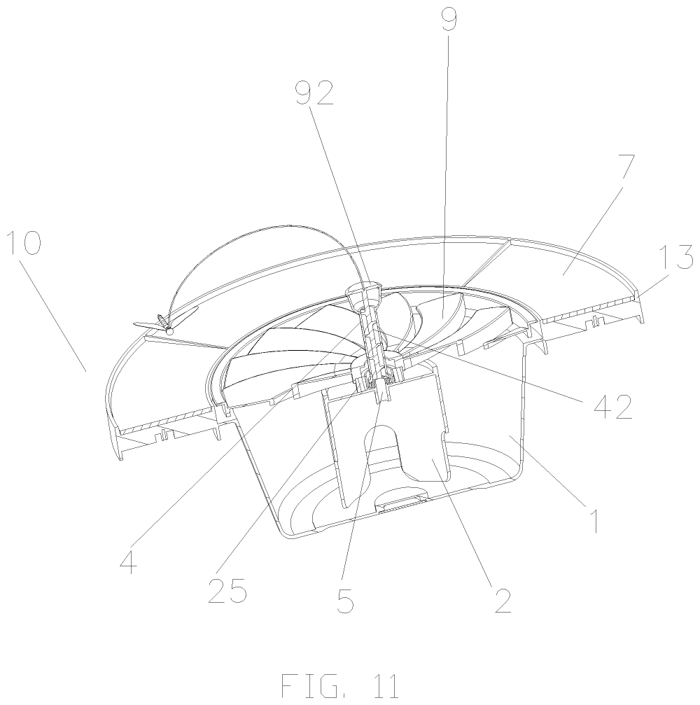

As shown in FIG. 10 and FIG. 11, this embodiment differs from Embodiment 1 in that the spray head 4 may be mounted on the upper end surface of the mounting base 2 in a manner such that the spray head 4 is capable of automatic rotation under impact of water flow; in addition, the decorative cover 9 allowing water to enter is disposed on the water storage basin 1, and the decorative cover is mounted on the water storage basin 1 in a manner such that the decorative cover is capable of automatic rotation under impact of water flow.

The rotating structure of the spray head 4 under the impact of the water flow is the same as the structure described in Embodiment 2, and so the description thereof is not repeated herein. The rotating structure of the decorative cover 9 under the impact of the water flow is the same as the structure described in Embodiment 3, and so the description thereof is not repeated herein.

According to the fountain device in this embodiment, during operation, the water pump 3 pumps the water in the water storage basin 1 into the spray head 4 through the water-conveying channel 5. Due to the arrangement of the spiral structure, water flow spirals up to drive the connecting rod 422 to rotate, thereby driving the spray head 4 to rotate; meanwhile, the water flow is sprayed out from the spray holes 41 to form a landscape in which the spray head 4 rotates and the water flow is sprayed. Then, the sprayed water flow falls onto the annular extension disc or the rotating blades 92, and the water falling onto the annular extension disc slides onto the rotating blades 92 or directly falls onto the rotating blades 92 to push the rotating blades 92 to rotate, so that the rotating blades 92 rotate. Finally, the water flows back into the water storage basin 1 for recycling.

### Embodiment 5

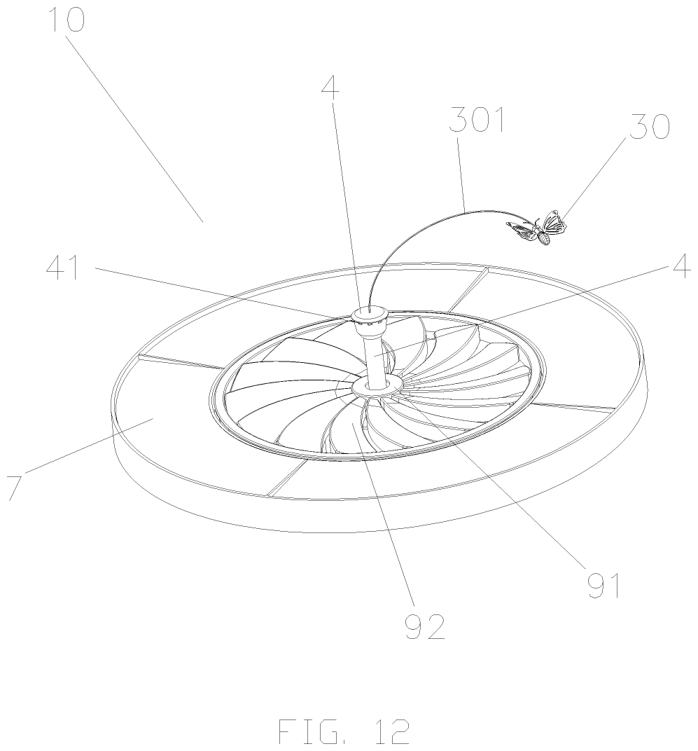

As shown in FIG. 12, this embodiment differs from Embodiment 2 in that an ornamental member 30 is connected to a middle position of the top cover 402 of the spray head 4.

Specifically, the ornamental member 30 may be an object in a geometrical shape, an animal shape, a flower shape, a leaf shape or the like to improve the aesthetic appeal and the ornamental performance of the device. For example, the ornamental member 30 may be a dragonfly-shaped or butterfly-shaped object. It should be noted that the specific shape of the ornamental member 30 is set according to actual situations, and is not limited herein.

Preferably, the ornamental member 30 is connected to the top cover 402 through a hard elastic member 301, that is, one end of the hard elastic member 301 is fixedly connected to the ornamental member 30, and the other end is fixedly connected to the top cover 402. In this embodiment, the hard elastic member 301 may be a steel wire rope or a nylon rope. In this embodiment, the hard elastic member 301 may be a hard elastic rope, a hard elastic tube or the like.

According to a fountain device in this embodiment, the ornamental member 30 may fall onto the upper side of the annular extension disc through the hard elastic member 301, and the ornamental member 30 rotates with the rotation of the spray head 4.

### Embodiment 6

As shown in FIG. 12, this embodiment differs from Embodiment 3 in that an ornamental member 30 is connected to the middle position of the top cover 402 of the spray head 4.

The ornamental member 30 is the same as the ornamental member described in Embodiment 5, and therefore, the description thereof is not repeated herein.

### Embodiment 7

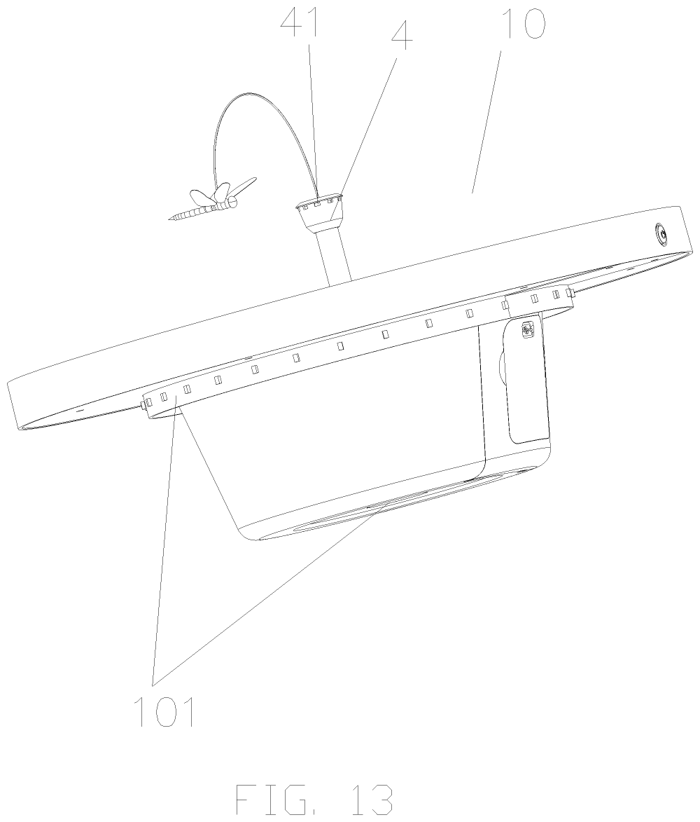

As shown in FIG. 13, this embodiment differs from Embodiment 1 in that at least one light-emitting lamp 101 is mounted on the fountain body 10, and a power supply end 608 of each light-emitting lamp is electrically connected to a third power output end 6023 of the control circuit 61 so that the light-emitting lamp 101 is turned on or off through the control circuit 61. The third power output end 6023 of the control circuit 61 constitutes a second power output end of the power supply module.

Specifically, the light-emitting lamp 101 may be disposed at the outer bottom of the water storage basin 1, the lower side surface of the annular extension disc 13 of the water storage basin 1, and/or the upper end surface of the mounting base 2, as described below.

Further, when the outer bottom of the water storage basin 1 is provided with the light-emitting lamp 101, the light-emitting lamp 101 is disposed at the middle position of the water storage basin 1; in this case, the light-emitting lamp 101 may be replaced with a light strip arranged around the bottom of the water storage basin 1.

Further, the lower side surface of the annular extension disc 13 is provided with the light-emitting lamp 101. The light-emitting lamp 101, in form of a light strip, is arranged around the lower side surface of the annular extension disc 13 with the axis of the annular extension disc 13 being the center.

Further, the light-emitting lamp 101 is a light strip. The light-emitting lamp 101 is arranged around an upper end surface of the middle column 26 of the mounting base 2 described in Embodiment 2, and correspondingly, the spray head 4 is a light-transmitting spray head 4; in addition, the light-emitting lamp 101 may also be arranged around a lower part of the spray head 4 that extends out of the water-conveying channel 5.

Further, the light-emitting lamp 101 is a light strip. The light-emitting lamp 101 is disposed around an upper end surface of the mounting protrusion 23 of the mounting base 2 described in Embodiment 3.

It should be noted that the arrangement of the light emitting-lamp 101 may be selected according to the foregoing structure, but the specific number and mounting position of the light-emitting lamp 101 may also be set according to actual situations, and are not limited to the foregoing arrangement.

### Embodiment 8

In this embodiment, Embodiment 7 may be combined with Embodiment 1 to form a fountain device with better aesthetic appeal, and correspondingly, the light-emitting lamp is arranged as described in Embodiment 7.

### Embodiment 9

In this embodiment, Embodiment 7 may be combined with Embodiment 2 to form a fountain device with better aesthetic appeal, and correspondingly, the light-emitting lamp is arranged as described in Embodiment 7.

### Embodiment 10

In this embodiment, Embodiment 7 may be combined with Embodiment 3 to form a fountain device with better aesthetic appeal, and correspondingly, the light-emitting lamp is arranged as described in Embodiment 7.

Preferably, the decorative cover in Embodiment 3 is a transparent cover, for example, a transparent cover made of an acrylic material, and one light-emitting lamp 101 is arranged on an upper side surface of the mounting protrusion 23, so that the light of the light-emitting lamp 101 may be transmitted, thereby improving the aesthetic appeal and the ornamental performance.

### Embodiment 11

In this embodiment, Embodiment 7 may be combined with Embodiment 4 to form a fountain device with better aesthetic appeal, and correspondingly, the light-emitting lamp is arranged as described in Embodiment 7.

Preferably, the decorative cover in Embodiment 4 is a transparent cover, for example, a transparent cover made of an acrylic material, and one light-emitting lamp 101 is arranged on the upper side surface of the mounting protrusion 23, so that the light of the light-emitting lamp 101 may be transmitted, thereby improving the aesthetic appeal and the ornamental performance.

### Embodiment 12

In this embodiment, Embodiment 7 may be combined with Embodiment 5 to form a fountain device with better aesthetic appeal, and correspondingly, the light-emitting lamp is arranged as described in Embodiment 7.

Preferably, the decorative cover in Embodiment 5 is a transparent cover, for example, a transparent cover made of an acrylic material, and one light-emitting lamp 101 is arranged on the upper side surface of the mounting protrusion 23, so that the light of the light-emitting lamp 101 may be transmitted, thereby improving the aesthetic appeal and the ornamental performance.

Preferably, the ornamental member 30 may be an ornamental member made of light-transmitting materials such as an acrylic plate. When light-emitting lamps are arranged on the fountain body 10 as described in Embodiment 7, preferably, two light-emitting lamps 101 are respectively arranged on the upper side surface of the mounting protrusion 23 and a lower part of the outside of the spray head 4 to adorn the ornamental member 30, so that the fountain body 10 is more beautiful and has better ornamental performance.

### Embodiment 13

In this embodiment, Embodiment 7 may be combined with Embodiment 6 to form a fountain device with better aesthetic appeal, and correspondingly, the light-emitting lamp is arranged as described in Embodiment 7.

Preferably, both the ornamental member 30 and the hard elastic member 301 may be made of light-transmitting materials, that is, the ornamental member 30 may be made of light-transmitting materials such as an acrylic plate, and the hard elastic member 301 may be a light-transmitting tube. When light-emitting lamps are arranged on the fountain body 10 as described in Embodiment 7, preferably, two light-emitting lamps 101 are respectively arranged on the upper side surface of the mounting protrusion 23 and a lower part of the outside of the spray head 4 to adorn the ornamental member 30, so that the fountain body 10 is more beautiful and has better ornamental performance.

The above description is only preferred embodiments of the present invention, and all equivalent changes and modifications made within the scope of the claims of the present invention should fall within the scope of the claims of the present invention.

What is claimed is:

1. A fountain device comprising a water storage basin, a mounting base and a water pump that are mounted in the water storage basin, a spray head mounted on the mounting base, and a power supply module mounted outside the water storage basin; a spray hole is provided on an upper end of the spray head; a water outlet end of the water pump is in communication with a water inlet end of the spray head; a drive end of the water pump is electrically connected with a power output end of the power supply module to enable power supply from the power supply module to the water pump.

2. The fountain device of claim 1, wherein the power supply module comprises a battery and a control circuit; the battery is in form of a storage battery; a first power input end of the control circuit is electrically connected to a power output end of the battery; a first power output end of the control circuit constitutes the power output end of the power supply module.

3. The fountain device of claim 2, wherein the battery is in form of a charging and discharging battery; the control circuit is in form of a charging and discharging control circuit; a solar panel is laid on an upper side surface of the water storage basin, and an output end of the solar panel is electrically connected to a second power input end of the control circuit; a second power output end of the control circuit is electrically connected to a power input end of the battery.

4. The fountain device of claim 3, wherein a mounting box is detachably provided outside the water storage basin; the power supply module is located in the mounting box.

5. The fountain device of claim 3, wherein it further comprises a base; the water storage basin is mounted on the base; the base is of a basin-shaped structure or a cylindrical structure.

6. The fountain device of claim 3, wherein a light-emitting lamp is disposed on a bottom part of the water storage basin and/or a lower side of an upper edge of the water storage basin and/or an upper side of the mounting base; a power supply end of the light-emitting lamp is electrically connected to a third power output end of the control circuit.

7. The fountain device of claim 3, wherein a switch button is mounted on an outer side or the upper side surface of the water storage basin; the switch button is electrically connected to a first signal input end of the control circuit.

8. The fountain device of claim 7, wherein a sensing probe is disposed on the water storage basin at a position close to the switch button; the sensing probe has a collecting end which is electrically connected to a second signal input end of the control circuit.

9. The fountain device of claim 3, wherein it further comprises a remote switch electrically connected to a third signal input end of the control circuit.

10. The fountain device of claim 3, wherein the spray head having a hollow interior is rotatably mounted on the mounting base; a spiral member for driving rotation of the spray head is disposed in the interior of the spray head; the spray hole is more than one in number; the spray holes are circumferentially arranged at intervals on the spray head.

11. The fountain device of claim 10, wherein the spiral member comprises a connecting rod and a spiral structure disposed on the connecting rod; the spiral structure comprises a spiral blade which spirals from bottom to top of the connecting rod; a first end of the connecting rod is mounted at a top part of the spray head, and a second end of the connecting rod is adjacent to an upper end surface of the mounting base.

12. The fountain device of claim 10, wherein the spiral member is located on an upper side inside the spray head; the spiral member comprises a connecting rod and a spiral structure disposed on the connecting rod; the spiral structure comprises a plurality of spiral blades which are arranged around the connecting rod; each of the spiral blades is slanted clockwise or counterclockwise from top to bottom.

13. The fountain device of claim 11, wherein an ornamental member is disposed outside the top part of the spray head.

14. The fountain device of claim 12, wherein an ornamental member is disposed outside a top part of the spray head.

15. The fountain device of claim 13, wherein the ornamental member is connected to the spray head through a hard elastic member; the ornamental member is made of a light-transmitting material, and/or the hard elastic member is in form of a rope made of a light-transmitting material.

16. The fountain device of claim 14, wherein the ornamental member is connected to the spray head through a hard elastic member; the ornamental member is made of a light-transmitting material, and/or the hard elastic member is in form of a rope made of a light-transmitting material.

17. The fountain device of claim 3, wherein a decorative cover is disposed on the water storage basin; the decorative cover is provided with a plurality of water inlet gaps, and each of the water inlet gaps communicates with an interior of the water storage basin.

18. The fountain device of claim 17, wherein the decorative cover is mounted on the water storage basin in a manner such that the decorative cover is capable of automatic rotation under impact of water flow; the decorative cover comprises an annular ring and a plurality of rotating blades which are arranged around the annular ring; each of the rotating blades has a blade surface which is arranged to incline downwards in a clockwise or counterclockwise direction, and the water inlet gap is formed between every two adjacent rotating blades.

19. The fountain device of claim 17, wherein the decorative cover is made of a light-transmitting material.

20. The fountain device of claim 1, wherein a hand grip is provided at an outer side wall of the mounting base or an inner side wall of the water storage basin.
